(19) United States
(12) Patent Application Publication
(10) Pub. No.: US 2014/0098213 A1
(43) Pub. Date: Apr. 10, 2014

(54) IMAGING SYSTEM AND CONTROL METHOD FOR SAME

(71) Applicant: Canon Kabushiki Kaisha, Tokyo (JP)

(72) Inventors: Masanori Sato, Yokohama-shi (JP); Tomochika Murakami, Ichikawa-shi (JP)

(73) Assignee: Canon Kabushiki Kaisha, Tokyo (JP)

(21) Appl. No.: 14/036,217

(22) Filed: Sep. 25, 2013

(30) Foreign Application Priority Data
Oct. 5, 2012 (JP) 2012-223062
May 20, 2013 (JP) 2013-105956

(51) Int. Cl. G02B 21/36

(52) U.S. Cl. CPC G02B 21/367
USPC 348/79

(57) ABSTRACT

An imaging system according to the present invention comprises: an imaging unit configured to acquire a plurality of images by imaging an object a plurality of times while changing a focusing position in an optical axis direction of an imaging optical system; and a generation unit configured to generate, on the basis of the plurality of images acquired by the imaging unit, an image at arbitrary depth of field or an image of the object viewed from an arbitrary viewing direction. The image acquired by the imaging unit sometimes includes fixed pattern noises that appear in fixed positions. The imaging unit images the object a plurality of times while changing a position or an orientation of an imaging region such that relative positions of the fixed pattern noises to the object vary among the plurality of images.

### BACKGROUND OF THE INVENTION

1. Field of the Invention

The present invention relates to an imaging system and a control method for the imaging system.

2. Description of the Related Art

In the pathological field, as a substitute for an optical microscope, which is a tool for a pathological diagnosis, there is a virtual slide system that images a test sample placed on a slide and digitizes the image to enable the pathological diagnosis on a display. An optical microscopic image of a test sample of the related art can be treated as digital data by the virtual slide system. Consequently, advantages such as speedup of a remote diagnosis, explanation for a patient performed using a digital image, sharing of rare cases, and efficiency of education and practice are obtained.

Further, in order to virtualize and realize operation of the optical microscope in the virtual slide system, it is necessary to digitize an entire test sample image in the slide. By digitizing the entire test sample image, it is possible to observe, with viewer software operating on a PC or a work station, digital data created by the virtual slide system. The number of pixels of the digitized entire test sample image is usually several hundred million to several billion pixels. Therefore, a data amount is extremely large.

An amount of data created by the virtual slide system is enormous. Therefore, images ranging from a micro image (a details expansion image) to a macro image (an overall bird's-eye image) can be observed through expansion and reduction by a viewer. Various conveniences are provided. If all kinds of necessary information are acquired in advance, immediate display of images ranging from a low-magnification image and a high-magnification image can be performed at resolution and magnification desired by a user.

However, waviness due to unevenness of a cover glass, a slide glass, or a test sample (a specimen) is present in the slide. Even if there is no unevenness, since the test sample has thickness, a depth position where a tissue or a cell desired to be observed is present is different depending on an observation position (in the horizontal direction) of the slide. Therefore, a configuration for changing a focus position along an optical axis direction of an imaging optical system and imaging a plurality of images on one slide (object) is necessary. A plurality of image data acquired by such a configuration is referred to as “Z stack image” or “Z stack data”. Plane images of respective focusing positions forming the Z stack image or the Z stack data are referred to as “layer images”.

In the virtual slide system, usually, from the viewpoint of efficiency, a test sample is imaged in each of local regions using a high-magnification (high NA) objective lens and images obtained by the imaging are merged to generate an overall image. In this case, although spatial resolution of the overall image is high, depth of field is small (shallow). In the normal virtual slide system, a high-magnification image (e.g., objective lens magnification of 40 times) is reduced to generate a low-magnification image (e.g., objective lens magnification of 10 times). Therefore, the depth of field of the low-magnification image generated by the procedure is small compared with an optical microscopic image at the same magnification. Consequently, out-of-focus or the like, which should be absent in an original optical microscopic image, occurs. Usually, a pathologist performs screening of an overall image not to overlook a lesioned part in a diagnosis. For the screening, a low-magnification image with little image deterioration due to out-of-focus is necessary. As a technique for reducing the out-of-focus or the like, there is a depth-of-field control technique.

The depth-of-field control technique roughly includes two kinds of methods. One is a method for selecting in-focus regions from each of layer images of Z stack data and combining them to generate one image. In this specification, this method is referred to as “patch type method”. The other is a method for performing deconvolution of Z stack data and a blur function (for example, a Gaussian function) to thereby generate a desired depth controlled image. In this specification, this method is referred to as “filter type method”. Further, the filter type method includes a method for adding two-dimensional blur functions to layer images of Z stack data, respectively, and performing deconvolution, and a method for directly performing deconvolution of a desired blur function over entire Z stack data. In this specification, the former is referred to as “two-dimensional filter type method” and the latter is referred to as “three-dimensional filter type method”.

A related art concerning the depth-of-field control technique is disclosed in, for example, Japanese Patent Application Laid-Open No. 2007-128009. Specifically, Japanese Patent Application Laid-Open No. 2007-128009 discloses a configuration for expanding depth of field by applying, to a plurality of images in different focusing positions, coordinate conversion processing for matching the images to a three-dimensional convolution model and three-dimensional filtering processing for changing a blur on a three-dimensional frequency space. This method corresponds to the “three-dimensional filter type method” explained above.

However, the related art has problems explained below.

According to the method disclosed in Japanese Patent Application Laid-Open No. 2007-128009, it is possible to generate an image at arbitrary depth of field (a depth-of-field image) from a Z stack image. However, when the Z stack image for the depth-of-field image generation is acquired, in some case, fixed pattern noises (e.g., noises derived from a sensor (an image sensor included in an imaging apparatus)) are recorded in fixed positions of layer images and the fixed pattern noises of the layer images concentrate on one place. In other words, in some case, relative positions of the fixed pattern noises to an object are the same among a plurality of layer images. In particular, this tendency is conspicuous when an XY stage of the virtual slide system is fixed and a Z stage is driven to acquire a Z stack image. Even when the Z stage is fixed and imaging processing for layer images is performed while driving the XY stage, since positioning of the sensor is performed every time a focusing position changes, the fixed pattern noises concentrate on one place as in the driving method explained above. The Z stack image in which the fixed pattern noises concentrate on one place is different from an image to which the method disclosed in Japanese Patent Application Laid-Open No. 2007-128009 can be applied. Therefore, as a result, the quality of a generated depth controlled image is deteriorated.

### SUMMARY OF THE INVENTION

It is an object of the present invention to provide a technique that can vary relative positions of fixed pattern noises to an object among a plurality of layer images and improve the quality of an image at desired depth of field and an image of the object viewed from a desired viewing direction.

The present invention in its first aspect provides an imaging system comprising: an imaging unit configured to acquire a plurality of images by imaging an object a plurality of times while changing a focusing position in an optical axis direction of an imaging optical system; and a generation unit configured to generate, on the basis of the plurality of images acquired by the imaging unit, an image at arbitrary depth of field or an image of the object viewed from an arbitrary viewing direction, wherein the image acquired by the imaging unit sometimes includes fixed pattern noises that appear in fixed positions, and the imaging unit images the object a plurality of times while changing a position or an orientation of an imaging region such that relative positions of the fixed pattern noises to the object vary among the plurality of images.

The present invention in its second aspect provides a control method for an imaging system, comprising: an imaging step of acquiring a plurality of images by imaging an object a plurality of times while changing a focusing position in an optical axis direction of an imaging optical system; and a generating step of generating, on the basis of the plurality of images acquired in the imaging step, an image at arbitrary depth of field or an image of the object viewed from an arbitrary viewing direction, wherein the image acquired in the imaging step sometimes includes fixed pattern noises that appear in fixed positions, and in the imaging step, the object is imaged a plurality of times while a position or an orientation of an imaging region is changed such that relative positions of the fixed pattern noises to the object vary among the plurality of images.

According to the present invention, it is possible to vary relative positions of fixed pattern noises to an object among a plurality of layer images and improve the quality of an image at desired depth of field and an image of the object viewed from a desired viewing direction.

Further features of the present invention will become apparent from the following description of exemplary embodiments with reference to the attached drawings.

### BRIEF DESCRIPTION OF THE DRAWINGS

FIG. 1 is a configuration diagram of a virtual slide system according to a first embodiment;

FIG. 2 is a configuration diagram of a main measuring unit according to the first embodiment;

FIG. 3 is an internal configuration diagram of an image processing apparatus according to the first embodiment;

FIG. 4 is a flowchart for explaining a flow of Z stack data acquisition processing of the related art;

FIG. 5 is a schematic diagram showing Z stack data and a unit of imaging of the related art;

FIG. 6 is a flowchart for explaining a flow of Z stack data acquisition processing of the related art;

FIG. 7 is a flowchart for explaining a flow of Z stack data acquisition processing according to a first embodiment;

FIG. 8 is a schematic diagram of a positional deviation amount table according to the first embodiment;

FIG. 9 is a schematic diagram showing Z stack data and a unit of imaging according to the first embodiment;

FIG. 10 is a flowchart for explaining a flow of positional deviation amount table creation processing according to the first embodiment;

FIG. 11 is a schematic diagram showing a procedure for determining a positional deviation amount vector according to the first embodiment;

FIG. 12 is a flowchart for explaining a flow of positional deviation correction processing according to the first embodiment;

FIG. 13 is a schematic diagram showing a relation between a layer image and fixed pattern noise according to the first embodiment;

FIG. 14 is a schematic diagram showing dispersion of fixed pattern noise according to the first embodiment;

FIG. 15 is a flowchart for explaining a flow of Z stack data acquisition processing according to a second embodiment;

FIG. 16 is a schematic diagram showing a fixed pattern noise group lining up in an optical axis direction;

FIG. 17 is a schematic diagram showing a fixed pattern noise group lining up in a viewing direction other than the optical axis direction;

FIG. 18 is a flowchart for explaining a flow of positional deviation correction processing according to a fourth embodiment;

FIG. 19 is a flowchart for explaining a flow of processing according to a fifth embodiment;

FIG. 20 is a flowchart for explaining a flow of processing according to a sixth embodiment; and

FIG. 21 is a flowchart for explaining a flow of processing according to a seventh embodiment.

### DESCRIPTION OF THE EMBODIMENTS

Imaging systems and control methods for the imaging systems according to embodiments of the present invention are explained below with reference to the drawings.

### First Embodiment

A first embodiment of the present invention is explained with reference to the drawings.

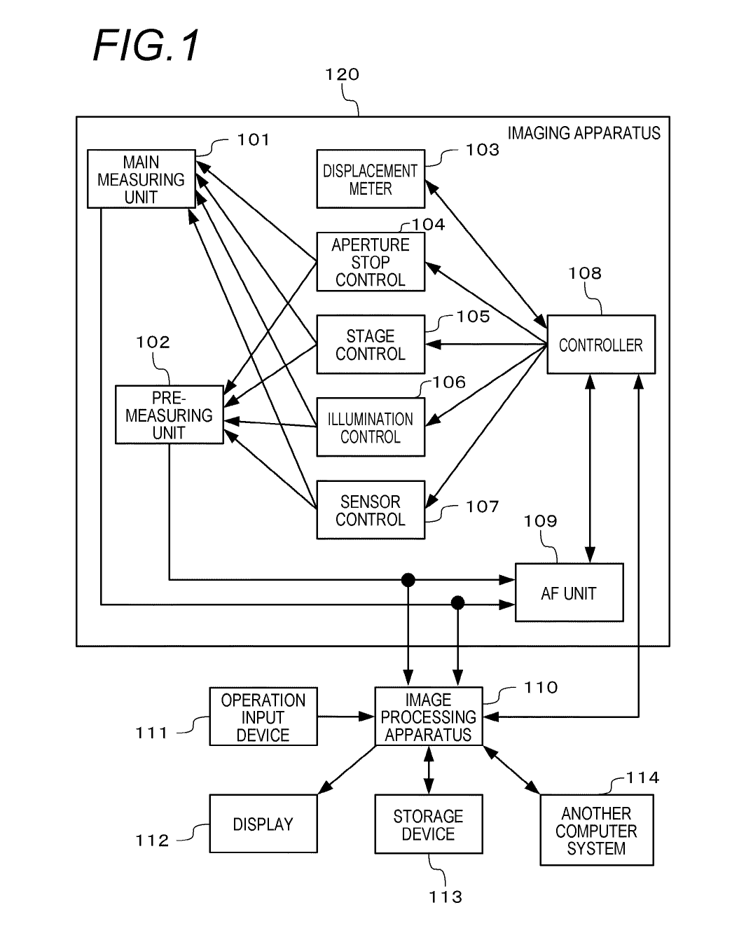

A method explained in the first embodiment is realized under a virtual slide system (an imaging system) having a configuration shown in FIG. 1.

The virtual slide system includes an imaging apparatus (also referred to as virtual slide scanner) 120 configured to acquire imaging data of an object, an image processing apparatus (also referred to as host computer) 110 configured to perform imaging data processing and control, and peripheral apparatuses of the image processing apparatus 110.

An operation input device 111 such as a keyboard and a mouse configured to receive an input from a user and a display 112 configured to display a processed image are connected to the image processing apparatus 110. A storage device 113 and another computer system 114 are connected to the image processing apparatus 110.

When imaging of a large number of objects (slides) is performed by batch processing, the imaging apparatus 120 images the objects in order under the control by the image processing apparatus 110. The image processing apparatus 110 applies necessary processing to image data (imaging data) of the objects. Obtained image data of the objects is transmitted to and accumulated in the storage device 113, which is a large-capacity data storage, and the other computer system 114.

Imaging (pre-measurement and main measurement) in the imaging apparatus 120 is realized by the image processing apparatus 110 receiving an input of the user and sending an instruction to a controller 108 and then the controller 108 controlling a main measuring unit 101 and a pre-measuring unit 102.

The main measuring unit 101 is an imaging unit configured to acquire a high definition image for a test sample diagnosis in a slide. The pre-measuring unit 102 is an imaging unit configured to perform imaging prior to main measurement. The pre-measuring unit 102 performs image acquisition with the object of acquisition of imaging control information for acquiring a highly accurate image in the main measurement.

A displacement meter 103 is connected to the controller 108 to enable measurement of the position of and the distance to a slide set on a stage in the main measuring unit 101 and the pre-measuring unit 102. The displacement meter 103 is used for measuring the thickness of a specimen in the slide in performing main measurement and pre-measurement.

An aperture stop control unit 104 for controlling an imaging condition of the main measuring unit 101 and the pre-measuring unit 102, a stage control unit 105, an illumination control unit 106, and a sensor control unit 107 are connected to the controller 108 and are respectively configured to control the operations of an aperture stop, a stage, illumination, and an image sensor according to control signals received from the controller 108.

The stage includes an XY stage that moves the slide in a direction perpendicular to an optical axis direction of an imaging optical system and a Z stage that moves the slide in a direction extending along the optical axis direction. The XY stage is used to change an imaging region (e.g., move the position of the imaging region in the direction perpendicular to the optical axis direction). A plurality of images distributed in the direction perpendicular to the optical axis direction (a plurality of images in different imaging regions) are obtained by imaging an object (the slide) while controlling the XY stage. The Z stage is used to change a focusing position in the optical axis direction (a depth direction). A plurality of images in different focusing positions are obtained by imaging the object while controlling the Z stage. Although not shown in the figure, a rack in which a plurality of slides can be set and a conveying mechanism configured to feed a slide from the rack to an imaging position on the stage are provided in the imaging apparatus 120. In the case of batch processing, the controller 108 controls the conveying mechanism, whereby the conveying mechanism feeds slides from the rack one by one to stages in order of a stage of the pre-measuring unit 102 and a stage of the main measuring unit 101.

An AF unit 109 configured to realize auto-focus using an imaged image is connected to the main measuring unit 101 and the pre-measuring unit 102. The AF unit 109 can find a focusing position by controlling the positions of the stages of the main measuring unit 101 and the pre-measuring unit 102 via the controller 108. A system of auto-focus is a passive type for performing the auto-focus using an image. A publicly-known phase difference detection system or contrast detection system is used.

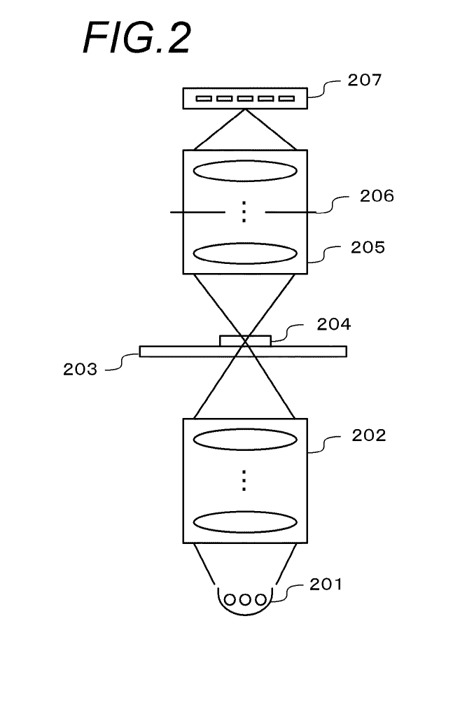

FIG. 2 is a diagram showing the internal configuration of the main measuring unit 101 in the first embodiment.

Light from a light source 201 is uniformalized in an illumination optical system 202 to eliminate light amount irregularity and irradiates a slide 204 set on a stage 203. As the slide 204 (an object), a slice of a tissue or a smeared cell to be observed is stuck on a slide glass and fixed under a cover glass together with a mounting agent. The slide 204 is prepared in a state in which the observation target can be observed.

An imaging optical system 205 enlarges an image of the object and guides the image to an imaging unit 207. The light passed through the slide 204 is imaged on an imaging surface on the imaging unit 207 via the imaging optical system 205. An aperture stop 206 is present in the imaging optical system 205. Depth of field can be controlled by adjusting the aperture stop 206.

In imaging, the light source 201 is lit to irradiate light on the slide 204. An image formed on the imaging surface through the illumination optical system 202, the slide 204, and the imaging optical system 205 is received by an imaging sensor of the imaging unit 207. During monochrome (gray scale) imaging, white light from the light source 201 is exposed and the imaging is performed once. During color imaging, red light, green light, and blue light from three light sources 201 of RGB are exposed in order and the imaging is performed three times to acquire a color image.

The image of the object formed on the imaging surface is photoelectrically converted by the imaging unit 207 and, after being A/D-converted by a not-shown A/D converter, sent to the image processing apparatus 110 as an electric signal. It is assumed that the imaging unit 207 is configured by a plurality of image sensors. However, the imaging unit 207 may be configured by a single sensor. In this embodiment, noise removal and development processing represented by color conversion processing and sharpening processing after the execution of the A/D conversion is performed inside the image processing apparatus 110. However, the development processing can be performed in a dedicated image processing unit (not shown in the figure) connected to the imaging unit 207 and thereafter data can be transmitted to the image processing apparatus 110. Implementation in such a form also falls within the scope of the present invention.

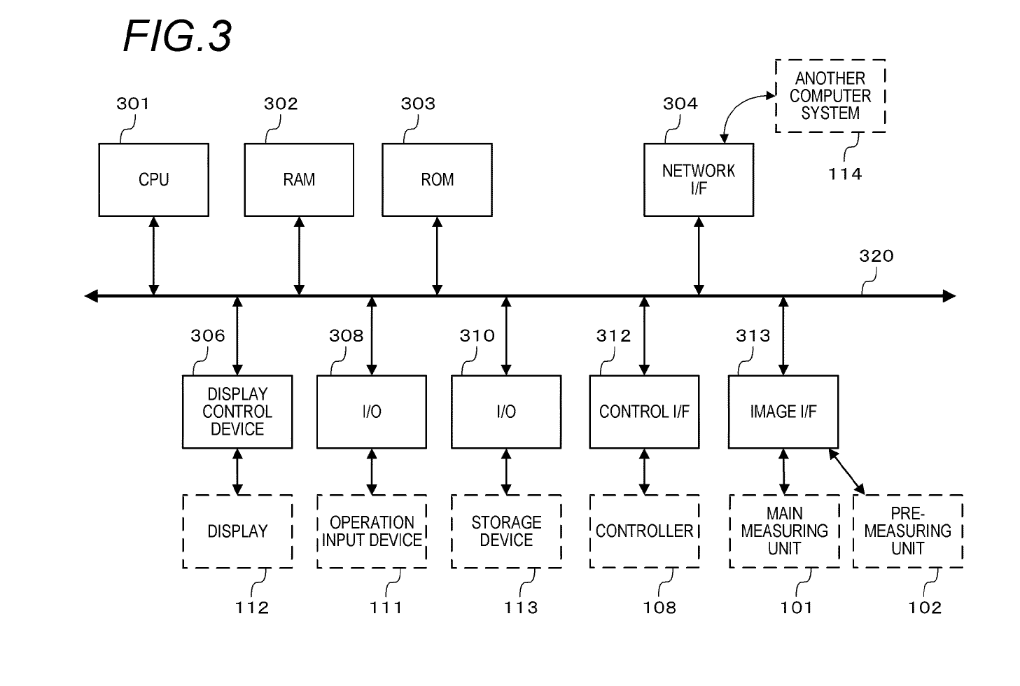

FIG. 3 is a diagram showing the internal configuration of the image processing apparatus (the host computer) 110.

A CPU 301 performs control of the entire image processing apparatus 110 using a program and data stored in a RAM 302 and a ROM 303. The CPU 301 performs various arithmetic processing and data processing such as depth-of-field expansion processing, development and correction processing, combination processing, and compression processing.

The RAM 302 temporarily stores a program and data loaded from the storage device 113 and a program and data downloaded from another computer system 114 via a network I/F (interface) 304. The RAM 302 includes a work area necessary for the CPU 301 to perform various kinds of processing.

The ROM 303 has stored therein a function program, setting data, and the like of the computer.

A display control device 306 performs control processing for causing the display 112 to display an image, a character, and the like. The display 112 displays an image for requesting the user to input data and displays an image (image data) acquired from the imaging apparatus 120 and processed by the CPU 301.

The operation input device 111 is configured by a device such as a keyboard and a mouse with which various instructions can be input to the CPU 301. The user inputs information for controlling the operation of the imaging apparatus 120 using the operation input device 111. Reference numeral 308 denotes an I/O for notifying the CPU 301 of various instructions and the like input via the operation input device 111.

The storage device 113 is a large-capacity information storage device such as a hard disk. The storage device 113 stores a program for causing the CPU 301 to execute an operating system (OS) and processing explained below, image data scanned by batch processing, and the like.

Writing of information in the storage device 113 and readout of information from the storage device 113 are performed via the I/O 310.

A control I/F 312 is an I/F for exchanging a control command (signal) with the controller 108 for controlling the imaging apparatus 120. The controller 108 has a function of controlling the main measuring unit 101 and the pre-measuring unit 102.

An interface other than the above such as an external interface for capturing output data of a CMOS image sensor or a CCD image sensor is connected to an image interface (I/F) 313. As the interface, a serial interface such as USB or IEEE1394 or an interface such as a camera link can be used. The main measuring unit 101 and the pre-measuring unit 102 are connected through the image I/F 313.

Reference numeral 320 denotes a bus used for transmission of a signal among the functional units of the image processing apparatus 110.

A flow of processing performed using the system shown in FIGS. 1 to 3 is explained below. In order to clarify a difference from the related art, first, processing of the related art for acquiring a Z stack image is explained. Thereafter, this embodiment is explained. The Z stack image is a plurality of images (layer images) obtained by imaging an object (a slide) a plurality of times while changing a focusing position in an optical axis direction of an imaging optical system.

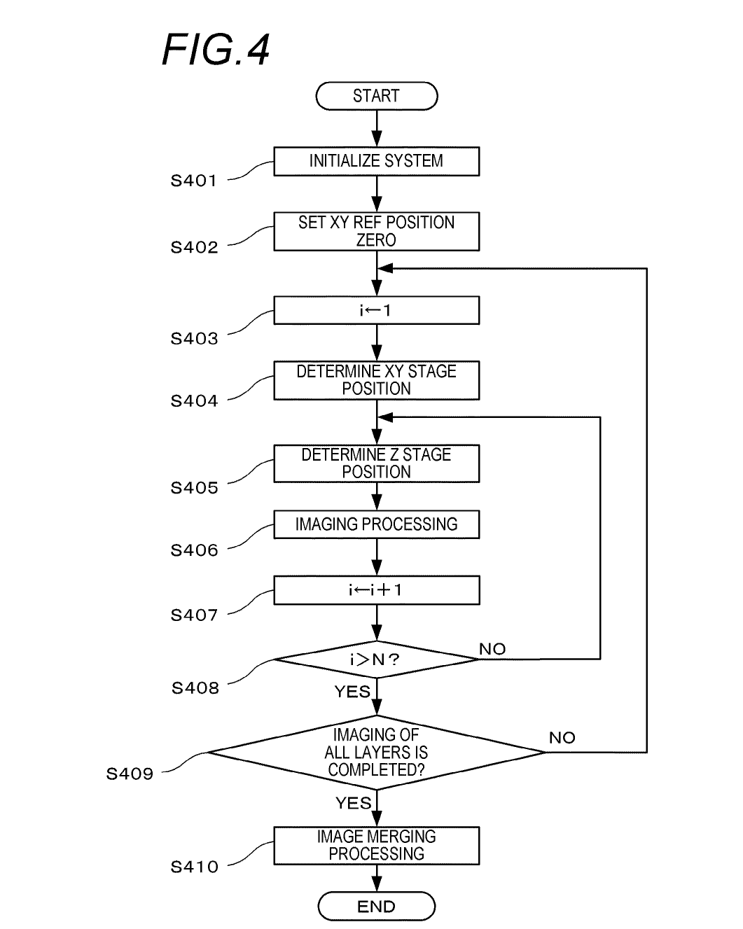

FIG. 4 is a flowchart for explaining an example of a flow of the processing of the related art. The processing is explained below with reference to FIG. 4.

First, the CPU 301 performs initialization processing for the virtual slide system (S401). The initialization processing includes processing such as a self-diagnosis of the system, initialization of various parameters, and mutual connection check among units.

Subsequently, the CPU 301 sets a position O serving as a reference for driving the XY stage (a reference position of the XY stage) (S402). The reference position O may be set in any way as long as the XY stage can be driven at necessary accuracy. However, irrespective of the driving of the Z stage, the reference position O is not changed when once set.

The CPU 301 substitutes 1 in a variable i (S403). The variable i represents a layer number. When the number of layers of an image to be acquired is N, the variable i takes values 1 to N. One layer corresponds to one focusing position.

The CPU 301 determines a position of the XY stage. The stage control unit 105 drives the XY stage to the determined position (S404). The position of the XY stage is determined using the reference position O set in S402. For example, when the shape of an effective imaging region of a sensor is a square having length L of a side, the XY stage is driven to a position deviated in both of an x direction and a y direction by length integer times as large as L with reference to the reference position O.

The CPU 301 determines a position of a Z stage (a position of the slide in a z direction). The stage control unit 105 drives the Z stage to the determined position (S405). Usually, during imaging of a Z stack image, focusing position data representing focusing positions of layers is given from the user. Therefore, a position (a focusing position) of the Z stage for imaging an image of the layer number i only has to be determined on the basis of the focusing position data.

Subsequently, the imaging unit 207 images the slide 204 (an optical image of a test sample present in the slide 204) (S406).

The CPU 301 adds 1 to the variable i (S407). This is equivalent to an instruction for changing a focusing position and imaging the next layer.

Subsequently, the CPU 301 determines whether a value of the variable i is larger than the number of layers N (S408). If the determination result in S408 is NO, the CPU 301 returns to S405. The Z stage is driven again in order to image the next layer and imaging is performed. If the determination result in S408 is YES, the CPU 301 determines whether imaging of all the layers is completed (S409). This is processing for determining whether imaging is performed for all positions of the XY stage. If the determination result in S409 is NO, the CPU 301 returns to S409. If the determination result in S409 is YES, the CPU 301 performs image merging processing (S410). Since an imaged image of one layer at this point is a group of small images having the size of the effective imaging region of the sensor, this is processing for merging (joining) the group of small images in a unit of layer. Thereafter, the series of processing ends. This is the end of the explanation of the processing shown in FIG. 4.

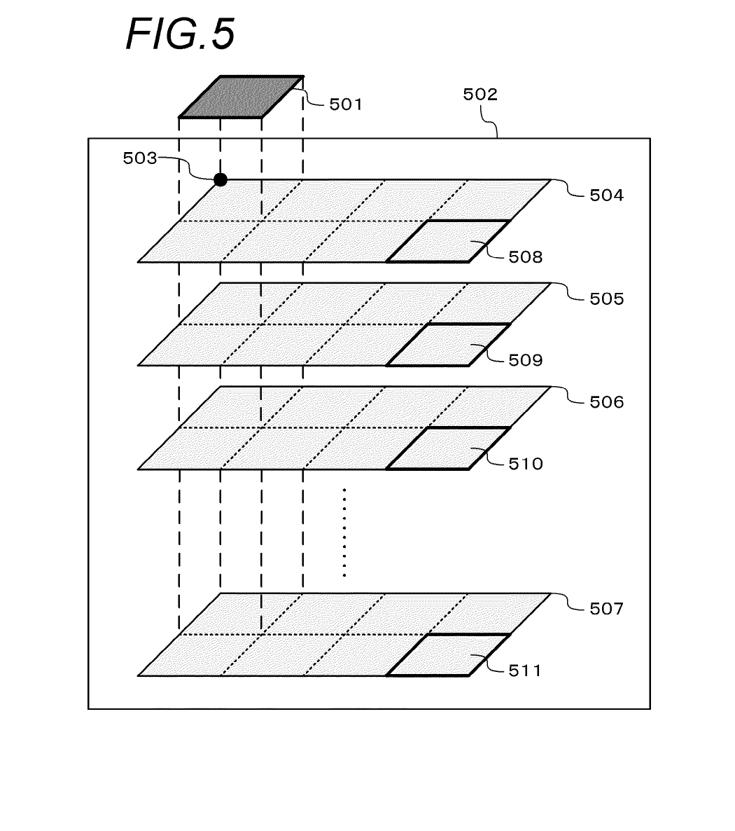

A schematic diagram of the processing is shown in FIG. 5. Reference numeral 501 denotes the effective imaging region of the sensor. A layer group 502 (a Z stack image) is imaged while the effective imaging region 501 is moved in the horizontal direction (a direction perpendicular to the optical axis direction) or the optical axis direction. Reference numeral 503 denotes the reference position O. Reference numerals 504 to 507 denote layers 1 to N to be imaged. Reference numerals 508 to 511 denote units of imaging in the layers. As it is seen from FIG. 5, the size of the unit of imaging coincides with the size of the effective imaging region 501. In one layer, effective imaging regions 501 are arranged without gaps in the horizontal direction. In the method shown in FIG. 4, the positions of the units of imaging 508 to 511 are positions set with reference to the reference position O. The units of imaging completely coincide with one another among the layers.

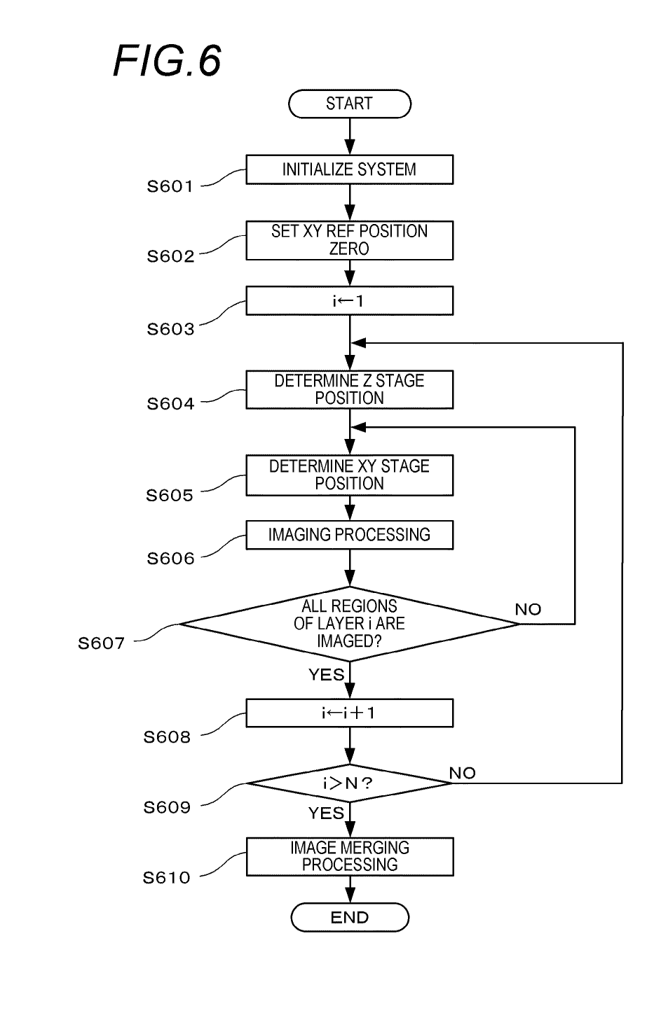

The Z stack data acquiring method explained with reference to FIG. 4 is a method of prioritizing a change of a focusing position in the optical axis direction and moving the imaging region in the horizontal direction every time imaging for all the focusing positions ends. On the other hand, in order to acquire the same Z stack data, a method of prioritizing region movement in the horizontal direction and, after imaging all regions of a certain layer, imaging another layer may be used. FIG. 6 is a flowchart for explaining a flow of such a procedure. The method shown in FIG. 6 is different from the method shown in FIG. 4 in that the movement of the imaging region in the horizontal direction is performed preferentially to the change of the focusing position in the optical axis direction. However, specific contents of respective kinds of processing shown in FIG. 6 are the same as the contents of the respective kinds of processing shown in FIG. 4. Therefore, details of the method are not explained.

Concerning these methods of the related art (the methods of acquiring a Z stack image), in this embodiment, roughly, two kinds of processing explained below are performed.

First processing is processing for acquiring Z stack data (a Z stack image) while causing positional deviation in the horizontal direction between the sensor and the object. Specifically, an acquired (imaged) image sometimes includes fixed pattern noises that appear in fixed positions. Therefore, as the first processing, processing for imaging the object a plurality of times while changing the position or the orientation of the imaging region is performed such that relative positions of the fixed pattern noises to the object vary among a plurality of images (a plurality of images in focusing positions different from one another). In this embodiment, as the first processing, processing for imaging the object a plurality of times while translating the image sensor or the object in a direction perpendicular to the optical axis direction is performed.

Second processing is processing for correcting positional deviation of the Z stack data obtained by the first processing. Specifically, as the second processing, processing for correcting an acquired plurality of images (a plurality of images in focusing positions different from one another) such that the positions and the orientations of the object of the plurality of images coincide with one another.

The fixed pattern noises are, for example, noises derived from the image sensor (e.g., a pixel defect caused by a failure of the A/D converter or the like). The fixed pattern noises are also sometimes caused by the influence of dust on the image sensor, illuminance irregularity of an illumination system of a microscope, or dust adhering to an objective lens of the microscope (e.g., dust adhering to an optical element near an intermediate image).

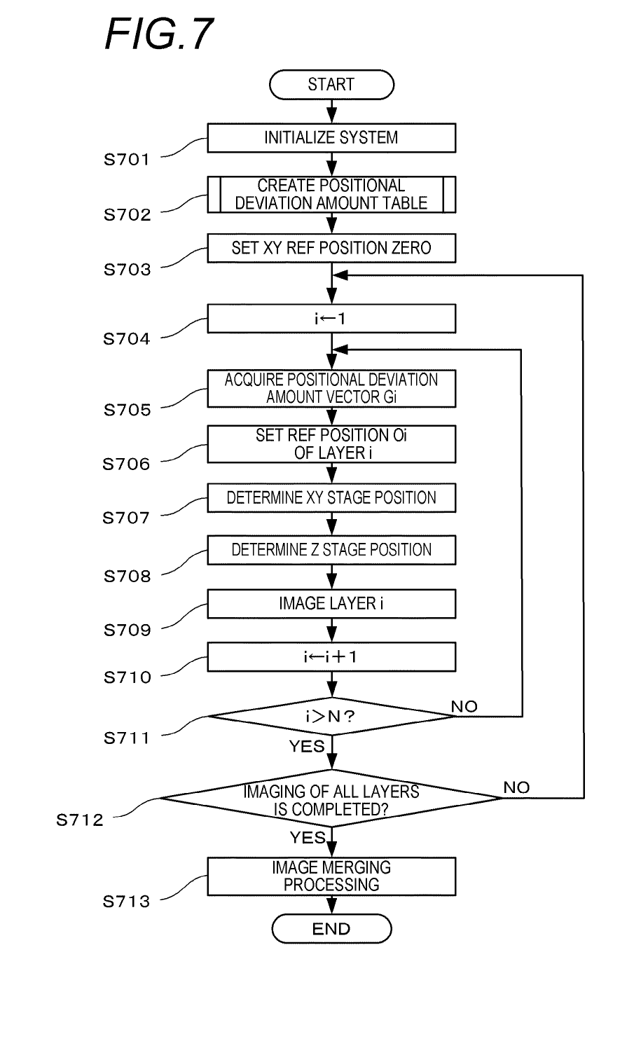

FIG. 7 is a flowchart for explaining an example of a flow of the processing (the processing for acquiring Z stack data) in this embodiment. The processing is explained below with reference to FIG. 7.

First, the CPU 301 performs initialization processing for the virtual slide system (S701). This processing is the same as S401.

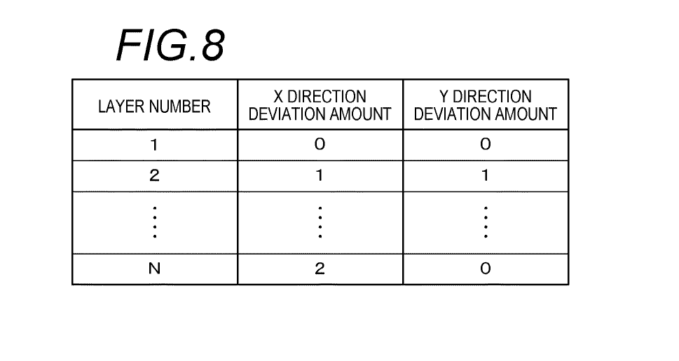

Subsequently, the CPU 301 creates a positional deviation amount table (S702). For example, as shown in FIG. 8, the table is a table for storing x direction deviation amounts and y direction deviation amounts of the layers. Details of processing in S702 are explained below.

The CPU 301 sets a position O serving as a reference for driving the XY stage (a reference position of the XY stage) (S703). This processing is the same as S402. The CPU 301 substitutes 1 in the variable i (S704). This processing is the same as S403.

The CPU 301 acquires a positional deviation amount vector G1 of a layer i from the positional deviation amount table created in S702 (S705). The positional deviation amount vector G1 is a two-dimensional vector having an x direction deviation amount and a y direction deviation amount as a set.

The CPU 301 sets a new reference position Oi in the layer i using the reference position O and the positional deviation amount vector G1 of the layer i (S706). The reference position Oi is a position deviated from the reference position O in the horizontal direction by the positional deviation amount vector G1.

The CPU 301 determines a position of the XY stage. The stage control unit 105 drives the XY stage to the determined position (S707). The position of the XY stage is determined using the reference position Oi of the layer set in S706. For example, when the shape of the effective imaging region of the sensor is a square having length L of a side, the XY stage in the layer i is driven to a position deviated in both of the x direction and the y direction by length integer times as large as L with reference to the reference position Oi.

Subsequently, the CPU 301 determines a position of the Z stage. The stage control unit 105 drives the Z stage to the determined position (S708). This processing is the same as S405. The imaging unit 207 images the slide 204 (an optical image of a test sample present in the slide 204) (S709). This processing is the same as S406.

Subsequently, the CPU 301 adds 1 to the variable i (S710). This processing is the same as S407.

The CPU 301 determines whether a value of the variable i is larger than the number of layers N (S711). If the determination result in S711 is NO, the CPU 301 returns to S705. If the determination result in S711 is YES, the CPU 301 determines whether imaging of all the layers is completed (S712). If the determination result in S712 is NO, the CPU 301 returns to S704. If the determination result in S712 is YES, the CPU 301 performs image merging processing (S713) same as S410. Thereafter, the series of processing ends.

This is the end of the explanation of the processing shown in FIG. 7.

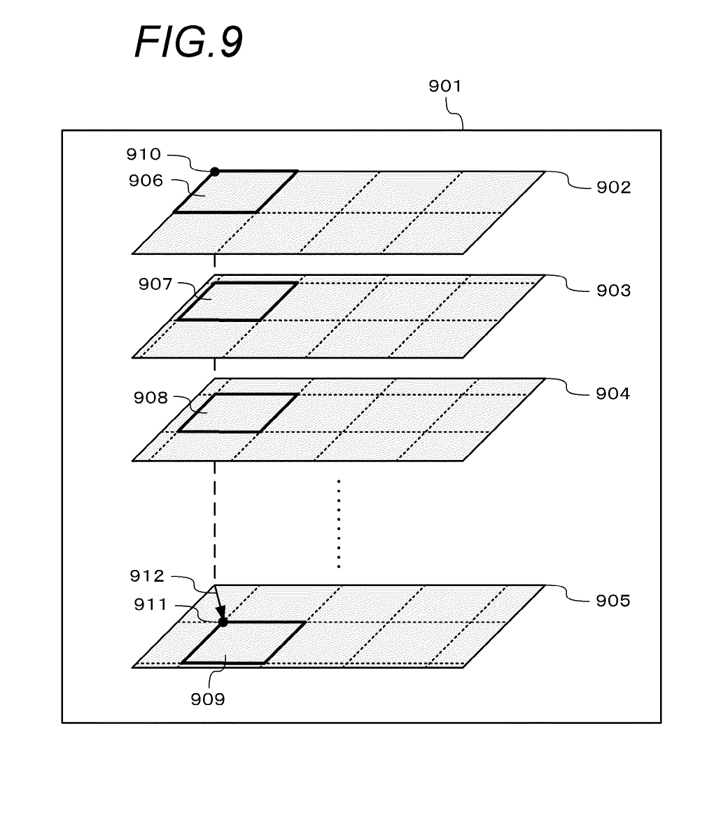

A schematic diagram of the processing shown in FIG. 7 is shown in FIG. 9. In imaging a layer group 901, a unit of imaging 906 of a layer 1 (902) is the same as the unit of imaging shown in FIG. 5. However, in imaging a layer 2 (903), a layer 3 (904), and a layer N (905), each of units of imaging 907, 908, and 909 of the layers moves in the horizontal direction. For example, in the case of the layer N (905), the unit of imaging 909 of the layer N (905) shifts to a position with a reference set in a new reference position 911 deviated from the reference position 910 by a positional deviation amount vector 912.

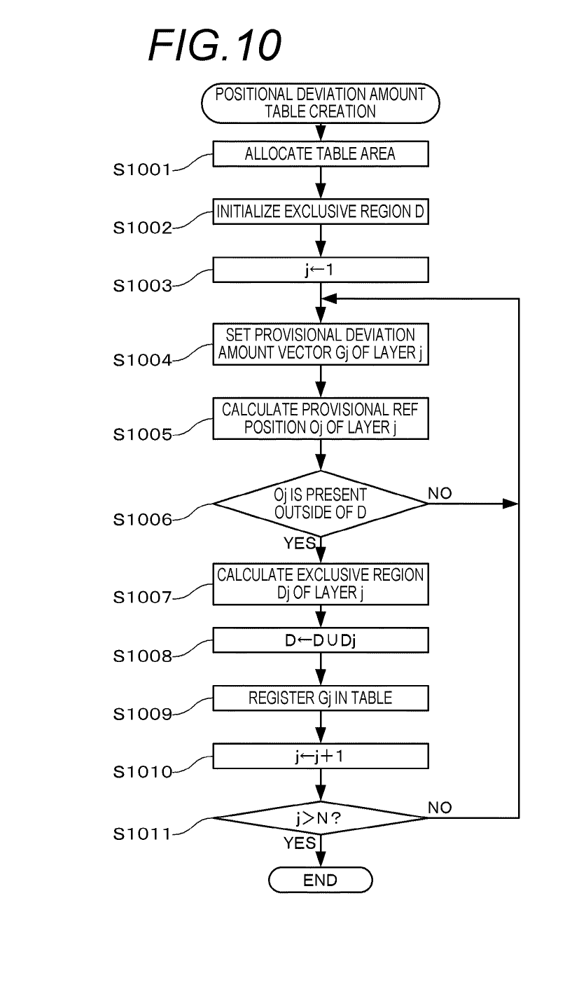

The processing for creating a positional deviation amount table (the processing in S702) is realized according to a flow of processing shown in FIG. 10. The processing is explained below with reference to FIG. 10.

First, the CPU 301 allocates, on the RAM 302, a table area for storing a positional deviation amount vector (S1001).

Subsequently, the CPU 301 performs initialization of an exclusive region D (S1002). The exclusive region D is a region for preventing reference positions of layers from overlapping one another. In S1002, the exclusive region D is initialized as an empty set, the area of which is zero.

The CPU 301 substitutes 1 in a variable j (S1003).

The CPU 301 sets a provisional positional deviation amount vector Gj in a layer j (S1004). As a method of determining Gj, several methods are conceivable. For example, a method of setting, as Gj, a random number having a certain value as a maximum value is conceivable. As a simpler method, a method of setting, as Gj, a vector obtained by always adding a certain constant vector to a positional deviation amount vector of the preceding layer is conceivable. When the image sensor includes a plurality of AD converters which are arrayed in a direction perpendicular to a line direction and each of which is configured to generate an image for one line, the direction of Gj may be set as an array direction of the AD converters (a direction perpendicular to the line). In particular, this setting method is effective when linear noise due to a failure of the AD converters is prevented.

The CPU 301 calculates, as a provisional reference position Oj in the layer j, a position deviated from the reference position O by the positional deviation amount vector Gj (S1005).

The CPU 301 determines whether the reference position Oj is present on the outside of the exclusive region D (S1006). If the determination result in S1006 is NO, the CPU 301 returns to S1004 and sets the provisional positional deviation amount vector Gj again. If the determination result in S1006 is YES, the CPU 301 calculates an exclusive region Dj in the layer j (S1007). In this embodiment, as Dj, a region on the inside of a circle with a radius r centering on Oj is calculated. As the radius r, a value for making it possible to surely prevent the influence on image quality due to concentration of fixed noise on one part is set. Specifically, it is preferable to set the value of the radius r to be equal to or larger than the length of one pixel of the sensor.

The CPU 301 ORs the exclusive region D and the exclusive region Dj in the layer j and defines the OR as a new exclusive region D (S1008).

The CPU 301 registers Gj in the positional deviation amount table as a regular positional deviation amount vector in the layer j (S1009).

The CPU 301 adds 1 to a value of j (S1010). The CPU 301 determines whether the value of j is larger than the number of layers N (S1011). If the determination result in S1001 is NO, the CPU 301 returns to S1004. If the determination result in S1011 is YES, the CPU 301 returns to S703 through a positional deviation amount table creation routine.

This is the end of the explanation of the processing shown in FIG. 10.

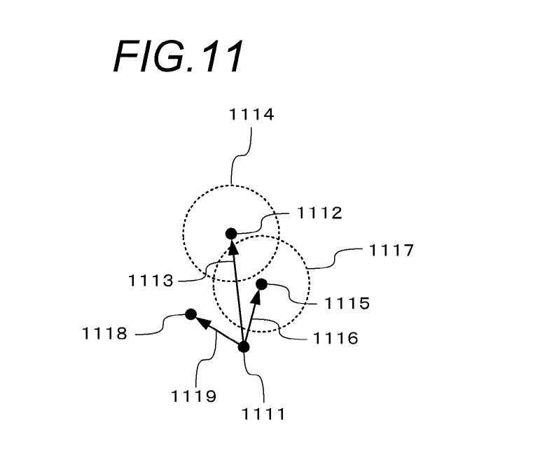

A schematic diagram of the processing shown in FIG. 10 is shown in FIG. 11. FIG. 11 shows the processing in S1004 performed when j=3.

Reference numerals 1112 and 1115 respectively denote a reference position O1 in the layer 1 and a reference position O2 in the layer 2. The reference positions O1 and O2 are positions translated from the reference position O (1111) by positional deviation amount vectors G1 (1113) and G2 (1116). Reference numerals 1114 and 1117 respectively denote an exclusive region D1 in the layer 1 and an exclusive region D2 in the layer 2. OR of the exclusive regions D1 and D2 is an exclusive region D at the present point. Reference numeral 1118 denotes a reference position O3 calculated using a provisional positional deviation amount vector G3 (1119) set in S1004 in FIG. 10. As it is seen from FIG. 11, if the processing is performed, irrespective of which combination of two reference positions Oj is selected, the two reference positions do not overlap each other. Therefore, if the processing shown in FIG. 7 is performed using the position deviation amount table created by the processing, it is possible to vary relative positions of fixed pattern noises to the object among a plurality of layer images.

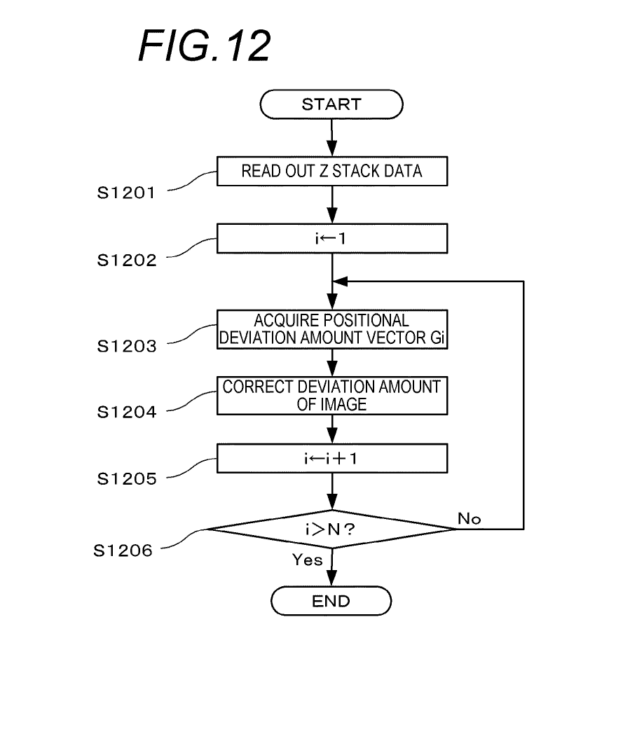

However, if the imaging processing shown in FIG. 7 is simply performed the position of the object is different among the layers. Therefore, it is necessary to perform positional deviation correction for layer images after the imaging processing. A flow of this processing is shown in FIG. 12.

First, the CPU 301 reads out, from the RAM 302, Z stack data created by the imaging processing shown in FIG. 7 (S1201).

Subsequently, the CPU 301 substitutes 1 in the variable i (S1202).

The CPU 301 acquires, from the positional deviation amount table created in S702, the positional deviation amount vector G1 in the layer i (S1203).

The CPU 301 corrects an image of the layer i (a layer image) on the basis of movement amounts of the imaging region (amounts of changes in a position and an orientation) by the processing in S707 in FIG. 7 (S1204). Specifically, the CPU 301 corrects positional deviation of the image of the layer i using the positional deviation amount vector G1 acquired in S1203.

The CPU 301 adds 1 to the value of the variable i (S1205).

Lastly, the CPU 301 determines whether the value of the variable i is larger than the number of layers N (S1206). If the determination result in S1206 is NO, the CPU 301 returns to S1203. If the determination result in S1206 is YES, the CPU 301 ends the processing.

This is the end of the explanation of the processing shown in FIG. 12.

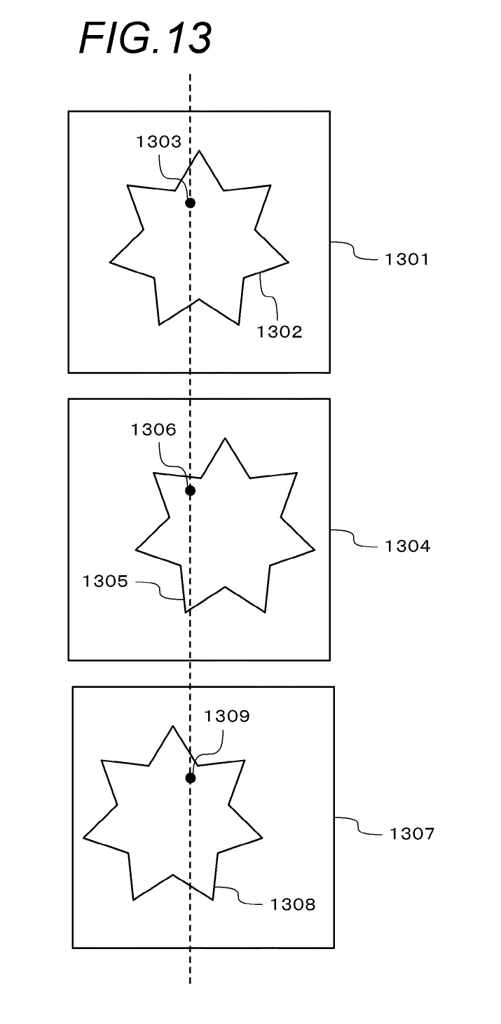

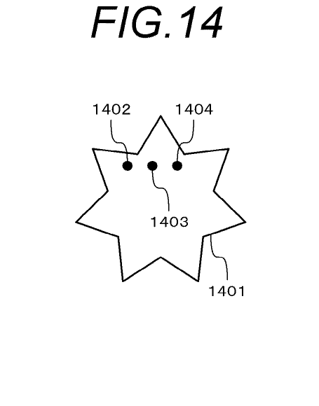

The processing shown in FIG. 12 is explained with reference to FIGS. 13 and 14.

FIG. 13 is a schematic diagram of an image acquired by the processing shown in FIG. 7 when a Z stack image includes three layer images. To simplify explanation, in the figures, it is assumed that the size of the layer images is equal to the effective imaging area of the sensor. The shape of an object is fixed irrespective of a focusing position. The Z stack image obtained under such conditions is formed by an image 1301 of the layer 1, an image 1304 of the layer 2, and an image 1307 of the layer 3. In the image 1301, the image 1304, and the image 1307, an object image 1302, an object image 1305, and an object image 1308 are respectively recorded. In the image 1301, the image 1304, and the image 1307, fixed pattern noise 1303, fixed pattern noise 1306, and fixed pattern noise 1309 are also respectively recorded. As it is seen from FIG. 13, naturally, the positions of the fixed pattern noises in the layer images do not change. However, it is seen that positional relations between the object images and the fixed pattern noises of the layer images are different from one another. When the processing shown in FIG. 12 is applied to the Z stack image, as shown in FIG. 14, the positions and the orientations of the object images of the layer images coincide with one another. FIG. 14 is a diagram in which the layer images are superimposed. It is seen from FIG. 14 that regions of the object images of the layer images are a region indicated by reference numeral 1401. According to the processing shown in FIG. 12, as shown in FIG. 14, the positions of the fixed pattern noises of the layer images are dispersed to positions indicated by reference numerals 1402, 1403, and 1404.

The CPU 301 generates, on the basis of the Z stack image acquired by the method explained above, an image at arbitrary depth of field and an image of the object viewed from an arbitrary viewing direction. Specifically, an image at arbitrary depth of field and an image of the object viewed from an arbitrary viewing direction are generated from the Z stack image after correction shown in FIG. 12. For example, an image at arbitrary depth of field is generated by a depth control technique of a filter type system in which a predetermined blur function is used. As shown in FIG. 14, since the positions of the fixed pattern noises of the layer images are dispersed, even in the image at arbitrary depth of field and the image of the object viewed from an arbitrary viewing direction, the fixed pattern noises are dispersed without concentrating on one part. Therefore, it is possible to reduce deterioration in image quality due to the fixed pattern noises (the quality of the image at arbitrary depth of field and the image viewed from an arbitrary viewing direction).

As explained above, according to this embodiment, it is possible to vary relative positions of fixed pattern noises to the object among a plurality of layer images and improve the quality of an image at desired depth of field and an image of the object viewed from a desired viewing direction.

In all combinations of two images among a plurality of images, it is preferable to change the position or the orientation of the imaging region such that a difference between the positions of the fixed pattern noises at the time when the positions and the orientations of the object of the two images are set to respectively coincide with each other is equal to or larger than one pixel. Specifically, it is preferable to set the length of a deviation amount vector registered in the positional deviation amount table to be equal to or larger than one pixel. Consequently, it is possible to more surely prevent the fixed pattern noises from concentrating on one part.

It is preferable to set the direction of the deviation amount vector in the array direction of the AD converters of the sensor. Consequently, even if linear noise due to a failure of the AD converters occurs, it is possible to more surely prevent the linear noise from concentrating on one part.

In this embodiment, in order to change the position of the imaging range, the object is moved using the XY stage. However, the position of the imaging range may be changed by moving the image sensor.

### Second Embodiment

A second embodiment of the present invention is explained with reference to the drawings.

The configuration of a virtual slide system, the configuration of a main measuring unit, and the internal configuration of an image processing apparatus that realize this embodiment are the same as those in the first embodiment.

In this embodiment, an effective imaging region of a sensor is a square and the sensor can be rotated around the center of the effective imaging region.

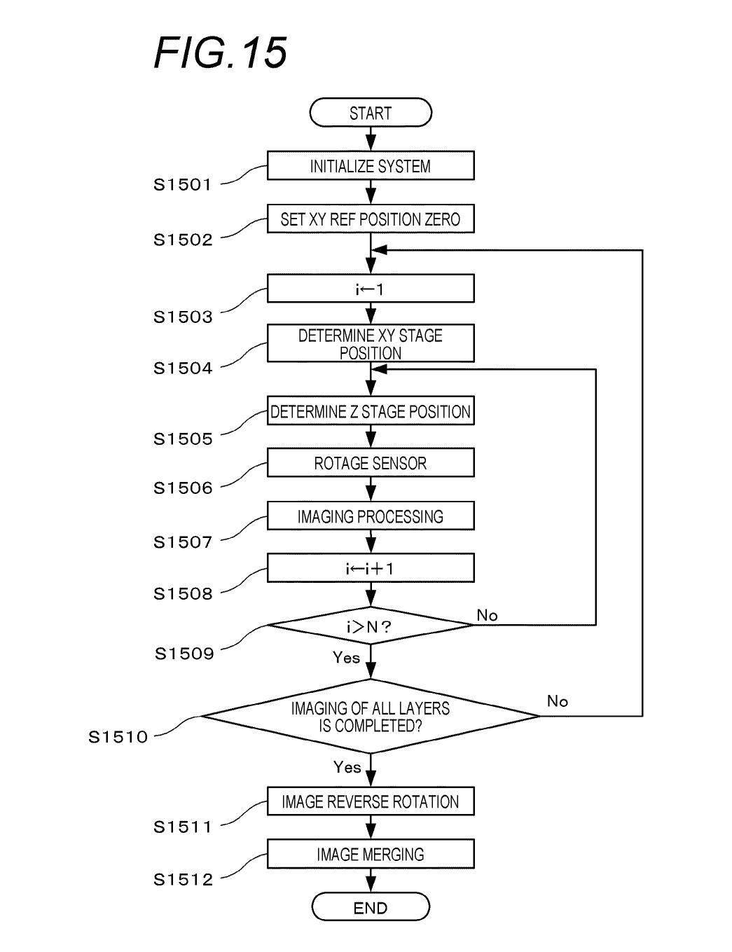

In the following explanation, taking into account the preconditions explained above, a flow of processing in this embodiment (processing for acquiring Z stack data) is explained with reference to a flowchart in FIG. 15.

In S1501 to S1505, S1507 to S1510, and S1512 shown in FIG. 15, processing same as S401 to S405, S406 to S409, and S410 shown in FIG. 14 is respectively performed. The processing shown in FIG. 15 is different from the processing shown in FIG. 4 in that the sensor is rotated in S1506 and a group of small images is reversely rotated in S1511. That is, processing in S1506 is performed, whereby, in this embodiment, an object is imaged a plurality of times while an image sensor is rotated around an axis in the optical axis direction. S1511 is processing equivalent to the positional deviation correction for an image explained in the first embodiment.

It is possible to disperse fixed pattern noises in layers according to rotation processing for the sensor (S1506) and inverse rotation processing for the group of small images (S1511). A method that can be most easily realized by the rotation of the sensor is a method of rotating the sensor 90 degrees clockwise or counterclockwise every time a layer is changed. In S1506, the sensor may be rotated at an angle other than 90 degrees. However, in that case, it is necessary to calculate an appropriate stage position to prevent omission of an imaging place in XY stage position determination in S1504. In image merging processing in S1512, additional processing for, for example, detecting overlap regions of images and merging the images is necessary.

As explained above, according to this embodiment, it is possible to vary relative positions of fixed pattern noises to the object among a plurality of layer images and improve the quality of an image at desired depth of field and an image of the object viewed from a desired viewing direction. In this embodiment, it is unnecessary to create a positional deviation amount table. Therefore, it is possible to simplify the processing compared with the first embodiment.

In this embodiment, the image sensor is rotated. However, the object may be rotated.

### Third Embodiment

A third embodiment of the present invention is explained with reference to the drawings.

The configuration of a virtual slide system, the configuration of a main measuring unit, and the internal configuration of an image processing apparatus that realize this embodiment are the same as those in the first embodiment. Flows of Z stack data acquisition processing and correction processing for correcting a positional deviation of a layer image are the same as those in the first embodiment. The third embodiment is different from the first embodiment in specific processing content of S1004 in FIG. 10.

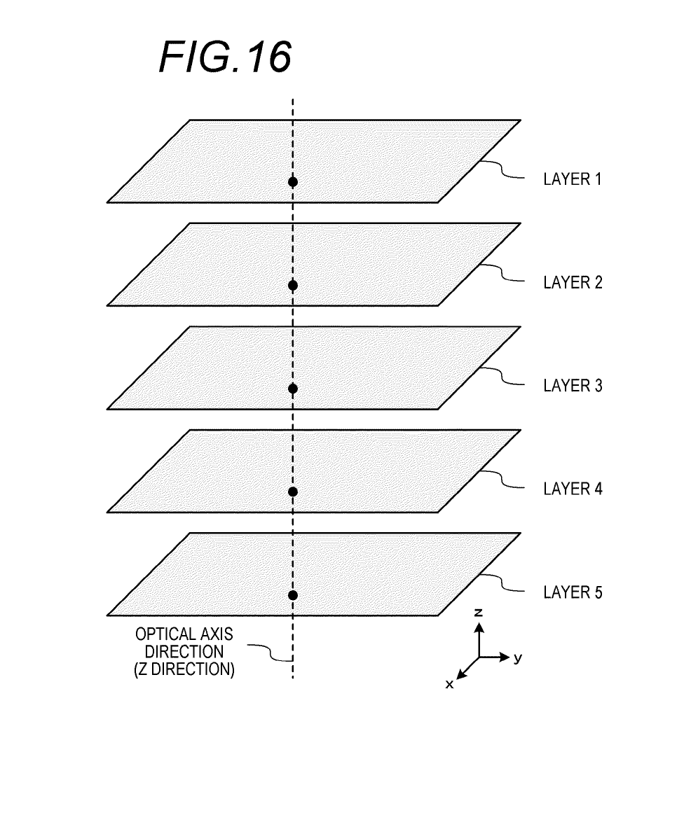

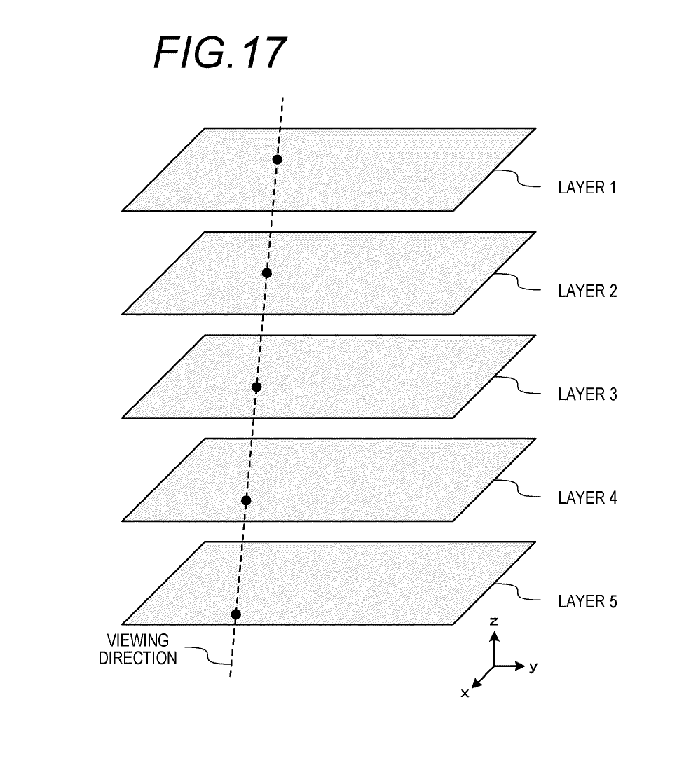

FIGS. 16 and 17 show an example in which Z stack data includes images of five layers 1 to 5.

The main purpose of the method in the first embodiment is to prevent deterioration in image quality due to fixed pattern noises lining up in the optical axis direction as shown in FIG. 16. In the method disclosed in Japanese Patent Application Laid-Open No. 2007-128009, it is possible to perform not only mere depth control but also generation of images (viewpoint images) of an object viewed from various viewing directions. In generating an image at arbitrary depth of field (a depth controlled image), fixed pattern noises only have to be prevented from lining up in the optical axis direction. However, in generating viewpoint images, even if fixed pattern noises do not line up in the optical axis direction, the quality of the viewpoint images is sometimes deteriorated by the fixed pattern noises. Specifically, when fixed pattern noises line up just in a certain viewing direction as shown in FIG. 17, the quality of the viewpoint images is deteriorated by the fixed pattern noises. In the method in the first embodiment, it is not always possible to surely prevent the deterioration in the image quality (prevent the fixed pattern noises from lining up in a certain viewing direction).

There is an upper limit in an angle in an arbitrary viewing direction with respect to the optical axis direction. That is, the arbitrary viewing direction is a direction in which an angle with respect to the optical axis direction is equal to or smaller than a predetermined angle.

Therefore, in this embodiment, in all combinations of two images among a plurality of images included in Z stack data, the position or the orientation of the imaging region is changed such that fixed pattern noise of one of the two images at the time when the positions and the orientations of the object of the two images are set to respectively coincide with each other is located further on the outer side than a direction which passes the position of fixed pattern noise of the other image and in which an angle with respect to the optical axis direction is the predetermined angle. Consequently, it is possible to surely prevent fixed pattern noises from lining up in a certain viewing direction.

For example, in the method disclosed in Japanese Patent Application Laid-Open No. 2007-128009, a maximum angle in the viewing direction with respect to the optical axis direction is determined by a numerical aperture of an objective lens used for imaging Z stack data. Therefore, in order to prevent fixed pattern noises from lining up in the viewing direction when a viewpoint image is generated, the numerical aperture of the objective lens and information concerning an acquisition interval of the Z stack data only have to be used.

Therefore, in this embodiment, in S1004, the provisional position deviation amount vector Gj is set using the numerical aperture of the objective lens used for imaging the Z stack data and the information concerning the acquisition interval of the Z stack data.

Specifically, processing explained below is performed in S1004.

When the aperture number of the objective lens is represented as δ, a refractive index of a medium between the object lens and the object is represented as n, and a maximum angle of a ray made incident on the objective lens from an object with respect to the optical axis direction (a maximum angle in an arbitrary viewing direction with respect to the optical axis direction) is represented as θ, the following Expression 1 holds:

δ=n×sin θ (1).

From θ satisfying Expression 1 and an acquisition interval of Z stack data (an interval of layers) L, the provisional positional deviation amount vector Gj is set with x calculated from the following Expression 2 set as a minimum value of the magnitude of the positional deviation amount vector Gj.

x=L×tan θ (2)

According to such a method, it is possible to set the positional deviation amount vector Gj that can surely prevent fixed pattern noises from lining up in a certain viewing direction.

As explained above, according to this embodiment, it is possible to vary relative positions of fixed pattern noises to the object among a plurality of layer images and improve the quality of an image at desired depth of field and an image of the object viewed from a desired viewing direction.

Further, according to this embodiment, it is possible to surely prevent fixed pattern noises from lining up in a certain viewing direction. Therefore, it is possible to improve the quality of an image of the object viewed from any viewing direction.

### Fourth Embodiment

A fourth embodiment of the present invention is explained with reference to the drawings.

The configuration of a virtual slide system, the configuration of a main measuring unit, and the internal configuration of an image processing apparatus that realize this embodiment are the same as those in the first embodiment. A flow of Z stack data acquisition processing is the same as that in the first embodiment. The third embodiment is different from the first embodiment in correction processing for correcting positional deviation of acquired Z stack data (positional deviation correction processing).

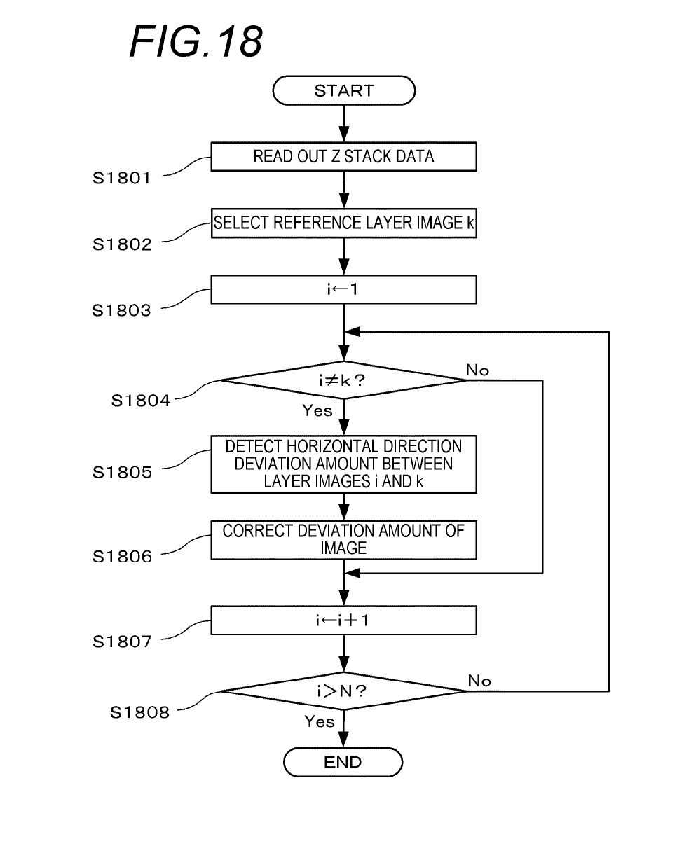

In this embodiment, feature points are detected from a plurality of images included in Z stack data and the plurality of images are corrected such that the positions of the detected feature points coincide with one another. Specifically, processing shown in FIG. 18 is performed as positional deviation correction processing for the Z stack data. The processing is explained with reference to FIG. 18.

First, the CPU 301 reads out, from the RAM 302, Z stack data generated by the processing shown in FIG. 7 (S1801).

Subsequently, the CPU 301 selects, from the Z stack data, one layer image k serving as a reference for correction of positional deviation (S1802).

The CPU 301 substitutes 1 in the variable i (S1803).

The CPU 301 determines whether a value of i is different from a value of k (S1804). If the determination result in S1804 is NO, the CPU 301 proceeds to S1807 (explained below). If the determination result in S1804 is YES, the CPU 301 detects, as a horizontal direction deviation amount, a deviation amount of the position (the position in the horizontal direction) of the object between the layer image i and the layer image k (S1805). Specifically, the CPU 301 applies a feature point extraction algorithm to the images to extract feature points and sets, as the horizontal direction deviation amount, a deviation amount between common feature points of the layer image i and the layer image k.

The CPU 301 corrects the deviation amount of the layer image i using the horizontal direction deviation amount obtained in S1805 (S1806). Specifically, the CPU 301 shifts the layer image i in the horizontal direction by the horizontal direction deviation amount obtained in S1805.

The CPU 301 adds 1 to the value of the variable i (S1807).

Lastly, the CPU 301 determines whether the value of the variable i is larger than the number of layers N (S1808). If the determination result in S1808 is NO, the CPU 301 returns to S1804. If the determination result in S1808 is YES, the CPU 301 ends the processing.

This is the end of the explanation of the processing shown in FIG. 18.

In the positional deviation correction processing explained in this embodiment, unlike the first embodiment, it is unnecessary to use information other than the Z stack data. Therefore, for example, in acquiring Z stack data, even if a configuration for preventing concentration of fixed pattern noises using horizontal direction noise naturally caused by mechanical accuracy or the like without controlling the XY stage is used, it is possible to perform positional deviation correction for the Z stack data without a problem.

As explained above, according to this embodiment, it is possible to vary relative positions of fixed pattern noises to the object among a plurality of layer images and improve the quality of an image at desired depth of field and an image of the object viewed from a desired viewing direction. In particular, compared with the first embodiment, it is unnecessary to use information other than Z stack data. Therefore, in acquiring Z stack data, even if imaging is performed in a configuration for not performing control in the horizontal direction, it is possible to prevent concentration of fixed pattern noises without a problem.

### Fifth Embodiment

A fifth embodiment of the present invention is explained with reference to the drawings.

The configuration of a virtual slide system, the configuration of a main measuring unit, and the internal configuration of an image processing apparatus that realize this embodiment are schematically the same as those in the first embodiment.

In this embodiment, a “normal mode” and a “high quality mode” are prepared as operation modes of an imaging system (a virtual slide system). The “normal mode” is a mode for imaging an object a plurality of times without changing the position and the orientation of an imaging region. The “high quality mode” is a mode for imaging an object a plurality of times while changing the position or the orientation of an imaging region only when the number of times the imaging system images the object while changing the position or the orientation of the imaging region is larger than a threshold M. That is, the “high quality mode” is a mode for performing the processing shown in FIGS. 7 and 12 only when an acquired number of layer images included in Z stack data is larger than the threshold M.

The operation modes are not limited to the “normal mode” and the “high quality mode”. Operation modes other than the “normal mode” and the “high quality mode” may be prepared.

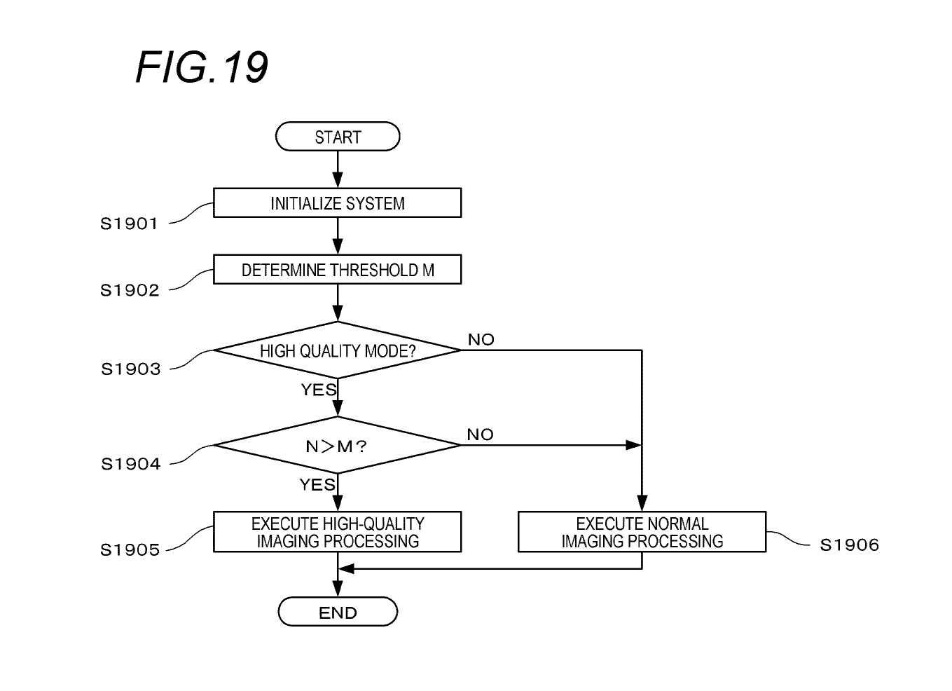

A flow of processing in this embodiment is explained using a flowchart in FIG. 19.

First, the CPU 301 performs initialization processing for the virtual slide system (S1901). This processing is the same as S401.

Subsequently, a threshold M is set (S1902). A user may manually set the threshold M or the CPU 301 may automatically set the threshold M using an internal state of the system. If the system automatically set the threshold M, a burden on the user decreases and operability of the system is improved.

The CPU 301 determines whether the high quality mode is effective (S1903).

When the high quality mode is effective, the CPU 301 determines whether a Z stack acquisition number N (an acquired number of layer images included in Z stack data; the number of times the imaging system images the object while changing a focusing position in the optical axis direction) is larger than the threshold M (S1904).

When N is larger than M, “high quality imaging processing” is executed (S1905) and the series of processing is finished. The “high quality imaging processing” is a series of processing for, after imaging the positional deviation image, in which the influence of fixed pattern noises is prevented, according to the processing shown in FIG. 7, applying the processing shown in FIG. 12 to the image to correct positional deviation of the image and acquiring a final image.

When the CPU 301 determines in S1903 that the high quality mode is ineffective (the normal mode is effective) and when the CPU 301 determines in S1904 that N is equal to or smaller than M, “normal imaging processing” is executed (S1906) and the series of processing is finished. The “normal imaging processing” is, for example, the processing indicated by S402 to S410 in FIG. 4 and S602 to S610 in FIG. 6.

This is the end of the processing explained with reference to FIG. 19.

In general, as an acquired number of layer images included in Z stack data increases, the influence of fixed noises accumulates and deterioration in the quality of a depth control image becomes more conspicuous. However, this problem can be solved by the application of the “high quality imaging processing”. This is explained in the first to fourth embodiments. However, the “high quality imaging processing” has a problem in that imaging speed is low compared with the “normal imaging processing”. In the “high quality mode” in this embodiment, the “high quality imaging processing” is performed when the influence of fixed pattern noises cannot be ignored. When the influence of fixed pattern noises is not so conspicuous, the “normal imaging processing” is performed and time required for imaging is reduced. Consequently, both of image quality and imaging speed are attained. A specific flow of the processing is the flow of the processing shown in FIG. 19.

As explained above, according to the “high quality mode” in this embodiment, processing for varying relative positions of fixed pattern noises is performed only when the influence of the fixed pattern noises cannot be ignored. Otherwise, the “normal imaging processing” is performed. Consequently, compared with the first to fourth embodiments, it is possible to improve the quality of a depth controlled image while minimizing a fall in imaging speed.

### Sixth Embodiment

A sixth embodiment of the present invention is explained with reference to the drawings.

The configuration of a virtual slide system, the configuration of a main measuring unit, and the internal configuration of an image processing apparatus that realize this embodiment are schematically the same as those in the first embodiment.

In this embodiment, a “normal mode” and a “high quality mode” are prepared as operation modes of an imaging system (a virtual slide system). The “normal mode” is the same as the “normal mode” in the fifth embodiment. However, the “high quality mode” is different from the “high quality mode” in the fifth embodiment. The “high quality mode” is a mode for imaging an object a plurality of times while changing the position or the orientation of an imaging region only when an amount of light obtained from the object is smaller than a threshold. Specifically, in the virtual slide system in this embodiment, besides the imaging explained with reference to FIG. 2, imaging of a fluorescent sample (fluorescent imaging) can be performed. The “high quality mode” is a mode for performing the processing shown in FIGS. 7 and 12 only when the fluorescent imaging is performed. When the fluorescent imaging is performed, an excitation light source is used as the light source 201. As the objective lens included in the imaging optical system 205, a dedicated objective lens with little intrinsic fluorescence is used. In the fluorescent imaging, fluorescence generated in an object by the irradiation of excitation light on the object is detected via the imaging optical system and a fluorescent image is acquired as an image (an imaged image) on the basis of a detection result.

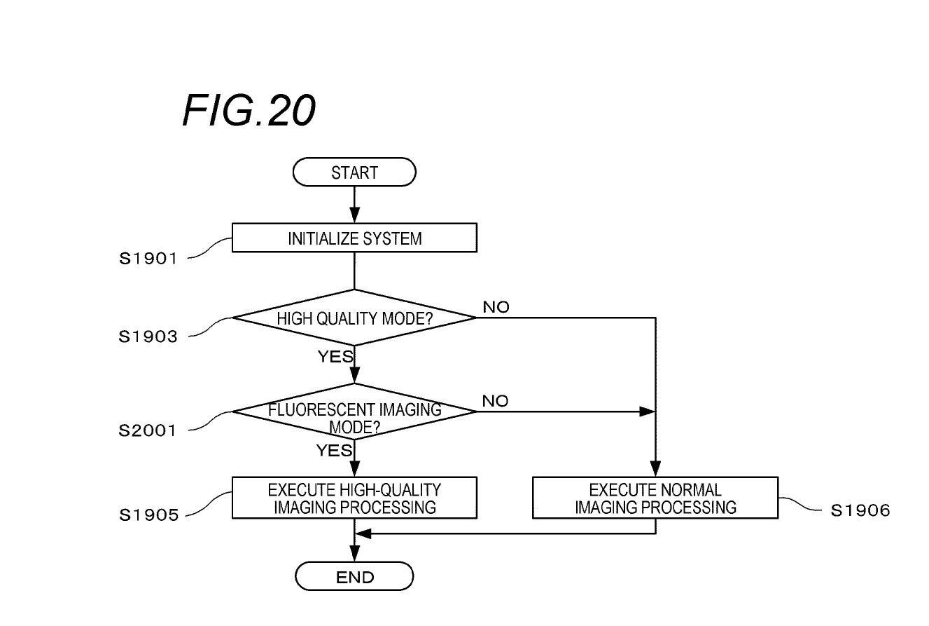

A flow of processing in this embodiment is explained with reference to a flowchart in FIG. 20.

First, the CPU 301 performs initialization processing for the virtual slide system (S1901).

Subsequently, the CPU 301 determines whether the high quality mode is effective (S1903).

When the high-quality mode is effective, the CPU 301 determines whether the imaging mode is a mode for performing the fluorescent imaging (a fluorescent imaging mode) (S2001).

When the imaging mode is the fluorescent imaging mode, the “high quality imaging processing” is executed (S1905) and the series of processing is finished. The “high quality imaging processing” in this embodiment is the same as the processing explained in the fifth embodiment.

When the CPU 301 determines in S1903 that the high quality mode is not effective and when the CPU 301 determines in S2001 that the imaging mode is not the fluorescent imaging mode, the “normal imaging processing” is executed (S1906) and the series of processing is finished. The “normal imaging processing” in this embodiment is the same as the processing explained in the fifth embodiment.

This is the end of the explanation of the processing shown in FIG. 20.

In general, when an amount of light obtained from an object to be imaged is small as in the fluorescent imaging, the influence of noise on an image signal relatively increases and deterioration in the quality of a depth controlled image becomes conspicuous. Naturally, the influence of fixed pattern noises also increases. However, this problem can be solved by the application of the “high quality imaging processing”. This is explained in the first to fourth embodiments. However, the “high quality imaging processing” has a problem in that imaging speed is low compared with the “normal imaging processing”. In the “high quality mode” in this embodiment, the “high quality imaging processing” is performed when the imaging mode is the fluorescent imaging mode. When the imaging mode is not the fluorescent imaging mode, the “normal imaging processing” is performed and time required for imaging is reduced. Consequently, both of image quality and imaging speed are attained. A specific flow of the processing is the flow of the processing shown in FIG. 20.

As explained above, according to the “high quality mode” in this embodiment, processing for varying relative positions of fixed pattern noises is performed only when an amount of light obtained from the object is small as in the fluorescent imaging mode. Otherwise, the “normal imaging processing” is performed. Consequently, compared with the first to fourth embodiments, it is possible to improve the quality of a depth controlled image while minimizing a fall in imaging speed.

In the example explained in this embodiment, the “high quality mode” is the mode for imaging an object a plurality of times while changing the position or the orientation of an imaging region only when the fluorescent imaging is performed. However, the “high quality mode” is not limited to this mode. The “high quality mode” only has to be a mode for imaging an object a plurality of times while changing the position or the orientation of an imaging region only when an amount of light obtained from the object is smaller than a threshold. For example, the “high quality mode” may be a mode for imaging an object a plurality of times while changing the position or the orientation of an imaging region only when a type of the object is a specific type.

### Seventh Embodiment

A seventh embodiment of the present invention is explained with reference to the figures.

The configuration of a virtual slide system, the configuration of a main measuring unit, and the internal configuration of an image processing apparatus that realize this embodiment are schematically the same as those in the first embodiment.

In this embodiment, a “normal mode” and a “high quality mode” are prepared as operation modes of an imaging system (a virtual slide system). In the virtual slide system in this embodiment, as in the sixth embodiment, fluorescent imaging is performed besides the imaging explained with reference to FIG. 2. The “normal mode” is the same as the “normal mode” in the fifth and sixth embodiments. However, the “high quality mode” is different from the “high quality mode” in the fifth and sixth embodiments. The “high quality mode” is a mode for imaging an object a plurality of times while changing the position or the orientation of an imaging region only when the number of times the imaging system images the object while changing a focusing position in the optical axis direction is larger than a threshold and the an amount of light obtained from the object is smaller than a threshold. Specifically, the “high quality mode” is a mode for performing the processing shown in FIGS. 7 and 12 only when an acquired number of layer images included in Z stack data is larger than the threshold M and the fluorescent imaging is performed.

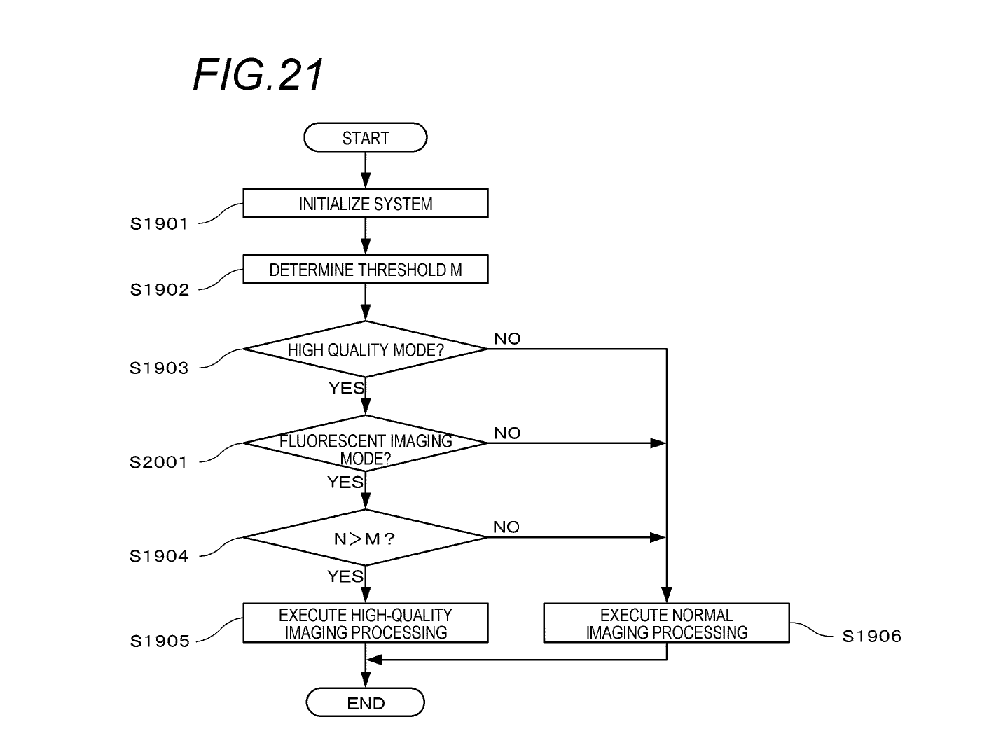

In this embodiment, processing obtained by combining the processing shown in FIG. 19 and the processing shown in FIG. 20 is performed. A flow of the processing in this embodiment is explained with reference to a flowchart in FIG. 21.

First, the CPU 301 performs initialization processing for the virtual slide system (S1901).

Subsequently, setting of the threshold M is performed (S1902).

Subsequently, the CPU 301 determines whether the high quality mode is effective (S1903).

When the high quality mode is effective, the CPU 301 determines whether the imaging mode is the fluorescent imaging mode (S2001).

When the imaging mode is the fluorescent imaging mode, the CPU 301 determines whether the Z stack acquisition number N is larger than the threshold M (S1904).

When N is larger than M, the “high quality imaging processing” is executed (S1905) and the series of processing is finished. The “high quality imaging processing” in this embodiment is the same as the processing explained in the fifth and sixth embodiments.

When the CPU 301 determines in S1903 that the high quality mode is not effective, the “normal imaging processing” is executed (S1906) and the series of processing is finished. When the CPU 301 determines in S2001 that the imaging mode is not the fluorescent imaging mode and when the CPU 301 determines in S1904 that N is equal to or smaller than M, the “normal imaging processing” is executed (S1906) and the series of processing is finished. The “normal imaging processing” in this embodiment is also the same as the processing explained in the fifth and sixth embodiments.

This is the end of the explanation of the processing shown in FIG. 21.

As explained in the fifth embodiment, in general, as an acquired number of layer images included in Z stack data increases, the influence of fixed noises accumulates and deterioration in the quality of a depth control image becomes more conspicuous. As explained in the sixth embodiment, when an amount of light obtained from an object to be imaged is small as in the fluorescent imaging, the influence of noise on an image signal relatively increases and deterioration in the quality of a depth controlled image becomes conspicuous. When both the effects overlap, the quality of an image is further deteriorated. However, this problem can be solved by the application of the “high quality imaging processing”. This is explained in the first to fourth embodiments. However, the “high quality imaging processing” has a problem in that imaging speed is low compared with the “normal imaging processing”. In the “high quality mode” in this embodiment, the “high quality imaging processing” is performed when fixed pattern noises are accumulated more than a threshold and the imaging mode is the fluorescent imaging mode. Otherwise, the “normal imaging processing” is performed. Consequently, both of image quality and imaging speed are attained. A specific flow of the processing is the flow of the processing shown in FIG. 21.

As explained above, according to the “high quality mode” in this embodiment, processing for varying relative positions of fixed pattern noises is performed only when fixed pattern noises are accumulated more than the threshold and an amount of light obtained when an object is small as in the fluorescent imaging. Otherwise, the “normal imaging processing” is performed. Consequently, compared with the first to fourth embodiments, it is possible to improve the quality of a depth controlled image while minimizing a fall in imaging speed.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium). Therefore, the computer (including the device such as a CPU or MPU), the method, the program (including a program code and a program product), and the non-transitory computer-readable medium recording the program are all included within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-223062, filed on Oct. 5, 2012 and Japanese Patent Application No. 2013-105956, filed on May 20, 2013, which are hereby incorporated by reference herein in their entirety.

What is claimed is:

1. An imaging system comprising:
an imaging unit configured to acquire a plurality of images by imaging an object a plurality of times while changing a focusing position in an optical axis direction of an imaging optical system; and
a generation unit configured to generate, on the basis of the plurality of images acquired by the imaging unit, an image at arbitrary depth of field or an image of the object viewed from an arbitrary viewing direction, wherein
the image acquired by the imaging unit sometimes includes fixed pattern noises that appear in fixed positions, and
the imaging unit images the object a plurality of times while changing a position or an orientation of an imaging region such that relative positions of the fixed pattern noises to the object vary among the plurality of images.

2. The imaging system according to claim 1, wherein, in all combinations of two images among the plurality of images, the imaging unit changes the position or the orientation of the imaging region such that a difference between positions of the fixed pattern noises at the time when positions and orientations of the object of the two images are set to respectively coincide with each other is equal to or larger than one pixel.

3. The imaging system according to claim 1, wherein
the arbitrary viewing direction is a direction in which an angle with respect to the optical axis direction is equal to or smaller than a predetermined angle, and
the imaging unit changes the position or the orientation of the imaging region such that, in all combinations of two images among the plurality of images, the fixed pattern noise of one of the two images at the time when positions and orientations of the object of the two images are set to respectively coincide with each other is located further on an outer side than a direction which passes a position of the fixed pattern noise of the other image and in which an angle with respect to the optical axis direction is the predetermined angle.

4. The imaging system according to claim 1, wherein the imaging unit includes an image sensor, and images the object a plurality of times while translating the image sensor or the object in a direction perpendicular to the optical axis direction.

5. The imaging system according to claim 4, wherein
the image sensor includes a plurality of AD converters which are arrayed in a direction perpendicular to a line direction and each of which is configured to generate an image for one line, and
the imaging unit images the object a plurality of times while translating the image sensor or the object in an array direction of the plurality of AD converters.

6. The imaging system according to claim 1, wherein the imaging unit includes an image sensor, and images the object a plurality of times while rotating the image sensor or the object around an axis parallel to the optical axis direction.

7. The imaging system according to claim 1, further comprising a correction unit configured to correct the plurality of images acquired by the imaging unit such that positions and orientations of the object of the plurality of images coincide with one another, wherein
the generation unit generates, from the plurality of images after the correction by the correction unit, the image at the arbitrary depth of field or the image of the object viewed from the arbitrary viewing direction.

8. The imaging system according to claim 7, wherein the correction unit corrects the plurality of images on the basis of an amount of change of the imaging region.

9. The imaging system according to claim 8, wherein the correction unit detects feature points from the plurality of images, and corrects the plurality of images such that positions of the detected feature points coincide with one another.

10. The imaging system according to claim 1, wherein the generation unit generates the image at the arbitrary depth of field using a predetermined blur function.

11. The imaging system according to claim 1, wherein the imaging system has a mode for imaging the object a plurality of times while changing the position or the orientation of the imaging region only when the number of times the imaging system images the object while changing the focusing position in the optical axis direction is larger than a threshold.

12. The imaging system according to claim 1, wherein the imaging system has a mode for imaging the object a plurality of times while changing the position or the orientation of the imaging region only when an amount of light obtained from the object is smaller than a threshold.

13. The imaging system according to claim 1, wherein the imaging system has a mode for imaging the object a plurality of times while changing the position or the orientation of the imaging region only when the number of times the imaging system images the object while changing the focusing position in the optical axis direction is larger than a threshold and an amount of light obtained from the object is smaller than a threshold.

14. The imaging system according to claim 12, wherein the amount of light obtained from the object becomes smaller than the threshold, when the imaging unit detects, via the imaging optical system, fluorescence generated in the object by irradiation of excitation light on the object and acquires a fluorescent image as the image on the basis of a detection result.

15. The imaging system according to claim 13, wherein the amount of light obtained from the object becomes smaller than the threshold, when the imaging unit detects, via the imaging optical system, fluorescence generated in the object by irradiation of excitation light on the object and acquires a fluorescent image as the image on the basis of a detection result.

16. A control method for an imaging system, comprising:
an imaging step of acquiring a plurality of images by imaging an object a plurality of times while changing a focusing position in an optical axis direction of an imaging optical system; and
a generating step of generating, on the basis of the plurality of images acquired in the imaging step, an image at arbitrary depth of field or an image of the object viewed from an arbitrary viewing direction, wherein
the image acquired in the imaging step sometimes includes fixed pattern noises that appear in fixed positions, and
in the imaging step, the object is imaged a plurality of times while a position or an orientation of an imaging region is changed such that relative positions of the fixed pattern noises to the object vary among the plurality of images.
